(19) United States
(12) Patent Application Publication
(10) Pub. No.: US 2023/0179720 A1
(43) Pub. Date: Jun. 8, 2023

(54) PRINT SYSTEM

(71) Applicant: SEIKO EPSON CORPORATION, Tokyo (JP)

(72) Inventors: Keisuke SASAKI, Matsumoto-shi (JP); Hideki MOROZUMI, Okaya-shi (JP)

(21) Appl. No.: 18/060,410

(22) Filed: Nov. 30, 2022

(30) Foreign Application Priority Data
Dec. 3, 2021 (JP) 2021-196717

(51) Int. Cl. H04N 1/00

(52) U.S. Cl. CPC H04N 1/00694; H04N 1/00708; H04N 1/00724; H04N 1/00464

(57) ABSTRACT

A printing system 1 configured to perform various settings of a printer 5 via a web browser 3 wherein the printer 5 is configured for selection and setting a type and a size of the sheet 7 via the web browser 3 and an operation panel 9 of the printer 5 is configured to enable selection and setting, for among predetermined types, a type of the sheet 7 that was placed in the sheet placed section 11 of the printer 5. The operation panel 9 is provided so that a document icon 13, a photograph icon 15, and an envelope icon 17 can be visually recognized.

The present application is based on, and claims priority from JP Application Serial Number 2021-196717, filed Dec. 3, 2021, the disclosure of which is hereby incorporated by reference herein in its entirety.

### BACKGROUND

### 1. Technical Field

The present disclosure relates to a printing system configured to perform various settings of a printer via a web browser.

### 2. Related Art

One example of such an image reading apparatus is a JP-A-2007-8704.

In JP-A-2007-8704, it is described that a size of a sheet is detected by a width sensor using an edge guide or the like that moves according to a width of the sheet when the sheet is placed in a sheet placed section of a printer.

The configuration described in JP-A-2007-8704 is capable of detecting the sheet, that is, the size of the sheet, by a width sensor, but cannot accurately distinguish between the sheet having a small size difference in a lateral direction, for example, A4 size and letter size. That is, in such a case, since the sheet size cannot be uniquely determined, there is a possibility of printing on a wrong sheet.

### SUMMARY

In order to solve the above problem, the printing system according to the present disclosure a printing system configured to perform various settings of a printer via a web browser wherein the printer is configured for selection and setting of a type and a size of a sheet via the web browser and an operation panel of the printer is configured to enable selection and setting, from among predetermined types, a type of the sheet that was placed in the printer.

### BRIEF DESCRIPTION OF THE DRAWINGS

FIG. 1 is a perspective view of a printing system according to an embodiment of the present disclosure.

FIG. 2 is a diagram illustrating types and sizes of a sheet selected via a web browser according to the embodiment.

FIG. 3 is a diagram of a selection screen on the web browser 3 according to the embodiment.

FIG. 4 is a plan view of a main section of an operation panel of the printer according to the embodiment.

FIG. 5 is a cross-sectional view of a main section of a sheet placed section of the printer according to the embodiment.

### DESCRIPTION OF EMBODIMENTS

The present disclosure present disclosure will be briefly described.

To solve the above problem, the printing system according to a first aspect of the present disclosure a printing system configured to perform various settings of a printer via a web browser wherein the printer is configured for selection and setting of a type and a size of a sheet via the web browser and an operation panel of the printer is configured to enable selection and setting, from among predetermined types, a type of the sheet that was placed in the printer.

Here, the “predetermined types” in “select and set the type of the sheet, which is placed in the printer, from among predetermined types” is determined corresponding to the type of the sheet selected via the web browser.

According to this aspect, the operation panel is configured to select and setting the type of the sheet placed in the printer from among predetermined types. As a result, it is possible to reduce the risk of printing on another type of the sheet by mistake for the type and the size of the sheet set via the web browser.

The printing system according to a second aspect of the present disclosure is the first aspect, wherein the printer includes a sensor configured to detect that the sheet was placed in a sheet placed section and when the sensor detects that the sheet was placed in the sheet placed section, the printer shifts to a type setting mode for setting, via the operation panel, the type of the sheet that was placed in the sheet placed section.

According to this aspect, the printer shifts to the type setting mode by the sensor detecting that the sheet is placed in the sheet placed section as a trigger. Thus, the user can set the type of the set sheet on the operation panel.

The printing system according to a third aspect of the present disclosure is the second aspect, wherein the predetermined types include n types of a first type, a second type, to an n-th type, wherein n is a positive integer, the operation panel has n display sections corresponding to the n types, and the type setting mode enables selection of any one type of sheet from the n types of sheets.

Here, “configured to select any one of the sheet from the n types of the sheet” in “the type setting mode is configured to select any one of the sheet from the n types of the sheet” means that one display section corresponding to the type of the sheet selected by the operation panel is turned on and the type of the selected sheet can be confirmed.

According to this aspect, the operation panel includes n display sections corresponding to the n types of the sheet. Thus, when any one of the n types of the sheet is selected by the operation panel in the state of the type setting mode, one of the n display sections corresponding to the selected sheet is turned on, and the type of the selected sheet can be confirmed. As a result, it can be easily confirmed that the correct sheet has been placed in the sheet placed section, and therefore, it is possible to reduce the possibility of printing on another type of the sheet by mistake.

The printing system according to a fourth aspect of the present disclosure is the third aspect, wherein the predetermined types are the three types of document, photograph, and envelope.

According to this aspect, the predetermined types are three types of document, photograph, and envelope. Since these are often used as a classification display of the type of the sheet, they are easy for the user to use.

The printing system according to the fifth aspect of the present disclosure is the third or fourth aspect, wherein the operation panel enables confirmation that the mode has been shifted to the type setting mode by turning on all of the n display sections.

According to this aspect, the fact that the printer has shifted to the type setting mode can be confirmed by the fact that all of the display sections are turned on. Therefore, the user can easily recognize that the type of sheet can be selected and set from among the predetermined types. thus, it is possible to start process of setting the type of the sheet.

A printing system according to a sixth aspect of the present disclosure is one of the first to fifth aspects, wherein the printer is configured to register the type and the size of the sheet set via the web browser.

Here, “configured to register” in “configured to register the type and the size of the sheet set via the web browser” means that the sheet of the type and the size that are frequently used among various types of the sheet is fixed in a changeable manner so that printing can be performed without performing setting processing each time.

According to this aspect, it is not necessary to perform a process of setting each time the type and the size that are frequently used by the user among various types of the sheet.

### EMBODIMENT

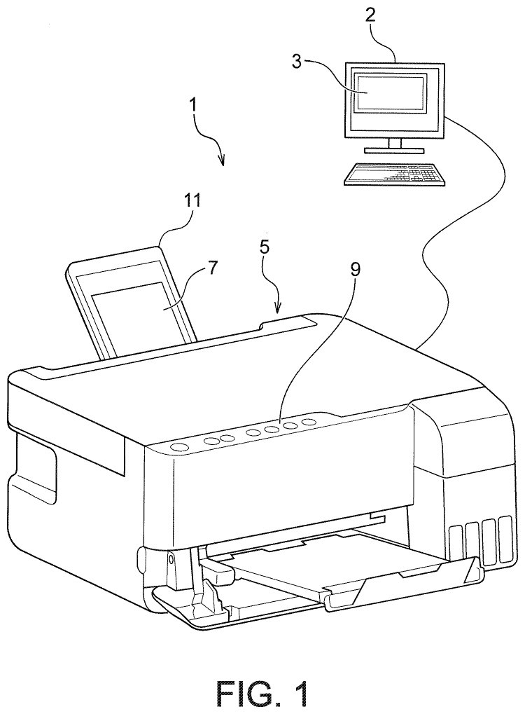

Hereinafter, a printing system according to an embodiment of the present disclosure will be specifically described with reference to FIGS. 1 to 5.

In the following description, three axes orthogonal to each other are referred to as an X-axis, a Y-axis, and a Z-axis, respectively, as shown in the drawings. The Z-axis direction corresponds to a vertical direction (a direction in which gravity acts). The X-axis direction and the Y-axis direction, correspond the horizontal direction.

As shown in FIG. 1, a printing system 1 according to this embodiment performs various settings of the printer 5 via a web browser 3. The printer 5 can select and set a type and a size of a sheet 7 via the web browser 3, and an operation panel 9 of the printer 5 enables selection and setting, from among predetermined types, the type of the sheet 7 that was placed in a sheet placed section 11 of the printer 5.

In this embodiment, the type and the size of the sheet to be printed can be placed by the user from a personal computer 2 connected to the printer 5 through the web browser 3 installed in the personal computer 2.

Each component will be described in detail below. Selection and Setting of Sheet Type and Size via Web Browser

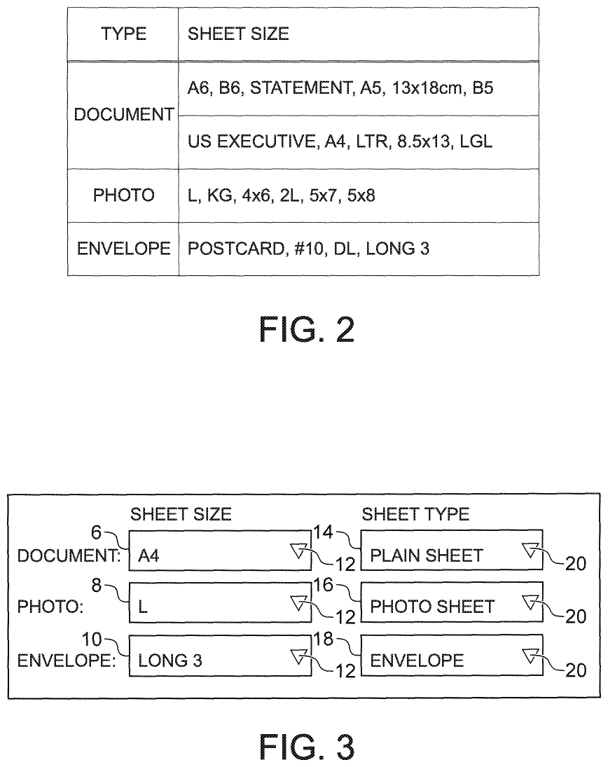

As shown in FIG. 2, in the present embodiment, the types of the sheet 7 are classified into three types of “document”, “photo”, and “envelope”. As the sheet size for “document”, a size such as A4, LTR, 8.5×13, and the like can be selected. For “photo”, a size such as a L, 4×6, 2L, and the like can be selected. For “envelope”, a size such as @10, DL, Long 3, and the like can be selected.

Note that the sheet sizes shown in FIG. 2 are examples, and these are not limitations.

As shown in FIG. 3, a selection screen on the web browser 3 includes a size window 6 for selecting “document” sheet size, a size window 8 for selecting “photo” sheet size, and a size window 10 for selecting “envelope” sheet size. The sheet sizes can be switched and selected using a selection mark 12. Here, the selection can be performed by software (WebConfig).

FIG. 3 shows a state where A4 is selected for “document”, sheet size L is selected for “photo”, and Long 3 is selected for “envelope”.

In this embodiment, one of a plurality of sheet types can be selected as the type of the sheet 7. There are a sheet type window 14 for selection from a plurality of types of “document”, a sheet type window 16 for selection from a plurality of types of “photo”, and a sheet type window 18 for selection from a plurality of types of “envelope”. Each sheet type can be switched and selected using a selection mark 20.

FIG. 3 shows a state in which plain sheet is selected as the sheet type for “document”, photo sheet is selected as the sheet type for “photo”, and envelope is selected as the sheet type for “envelope”. As the sheet type of “document”, there are super fine sheet, postcard, and the like in addition to plain sheet. For “photo”, there are glossy sheet, semi-glossy sheet, mat sheet, and the like in addition to photo sheet.

### Operation Panel

As described above, the operation panel 9 selects and sets the type of the sheet 7 placed in the sheet placed section 11 of the printer 5 from among predetermined types. Here, the “predetermined types” are determined in accordance with the type of the sheet selected via the web browser 3.

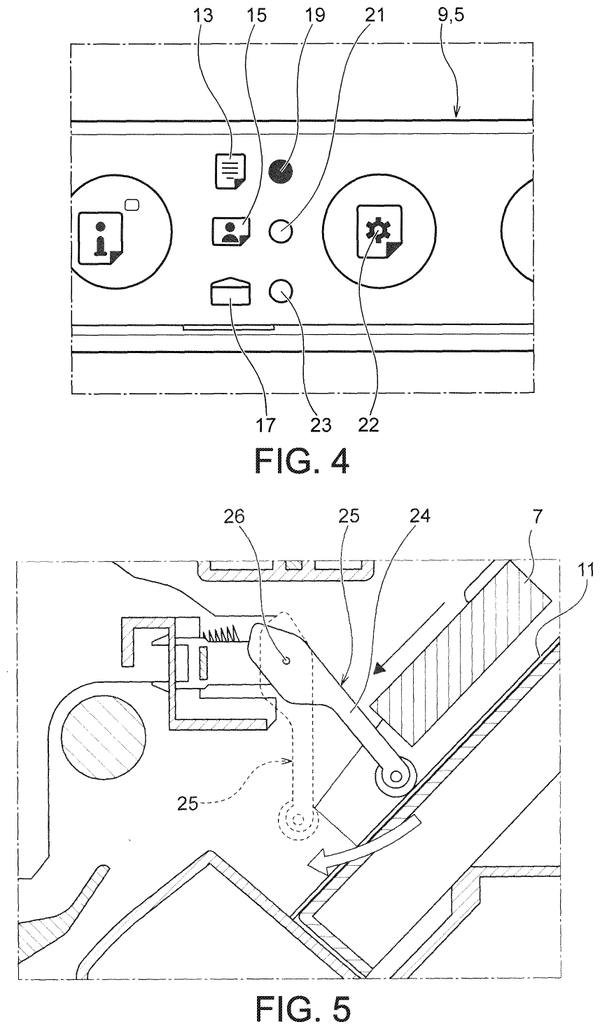

As shown in FIG. 4, in this embodiment, the operation panel 9 is configured to select any one of three types of “document”, “photo”, and “envelope” as the predetermined type. The predetermined types are not limited to three types of “document”, “photo”, and “envelope”. As the predetermined types, n types of a first type, a second type, to an n-th type (n is a positive integer) may be provided, and n display sections corresponding to the n types may be provided.

The operation panel 9 is provided so that a document icon 13 corresponding to “document”, a photograph icon 15 corresponding to “photo”, and an envelope icon 17 corresponding to “envelope” can be visually recognized.

Further, three display sections 19, 21, and 23 corresponding to the three types of “document”, “photo”, and “envelope” are provided. That is, the display section 19 is provided to the right of the document icon 13, the display section 21 is provided to the right of the photograph icon 15, and the display section 23 is provided to the right of the envelope icon 17. Here, the display sections 19, 21, and 23 are configured by LEDs, and are configured to emit light of different colors.

In FIG. 4, a reference numeral 22 denotes a selection button. When the user selects any one of the three types of “document”, “photo”, and “envelope” by the selection button 22, only the display section 19, 21, or 23 that corresponds to the type of the selected sheet 7 turns on. That is, the LED is configured to emit light.

### Type Setting Mode

In this embodiment, the sheet placed section 11 of the printer 5 is configured to placed three types of the sheet 7 of “document”, “photo”, and “envelope”.

As shown in FIG. 5, the printer 5 includes a sensor 25 configured to detect which of the three types of the sheet 7 has been placed in the sheet placed section 11. The sensor 25 is provided such that the lever 24 is pivotable with respect to a pivot fulcrum 26. In a state in which the sheet 7 is not placed in the sheet placed section 11, the lever 24 is at a position indicated by a solid line in FIG. 5, and when the sheet 7 is placed, the lever 24 is pushed by a tip end portion of the sheet 7 and pivots to a position indicated by a dashed line. By the pivot of the lever 24, it is detected that the sheet 7 was placed in the sheet placed section 11.

Then, when the sensor 25 detects that the sheet 7 was placed in the sheet placed section 11, a detection signal is sent to a control section (not shown) of the printer 5, and control is executed for shifting to a type setting mode for setting, via the operation panel 9, the type of the sheet 7 that was set. Then, the user uses the selection button 22 to select one of the three types of “document”, “photo”, and “envelope” as the type of sheet 7 that was placed in the sheet placed section 11.

In the present embodiment, the operation panel 9 is configured to confirm that the mode has been shifted to the type setting mode by all of the three display sections 19, 21, and 23 being turned ON. Here, all of the LEDs forming the display sections 19, 21, and 23 are turned on.

When the control section causes all three display sections 19, 21, and 23 to turn on, the user can check that the mode has shifted to the type setting mode.

In the present embodiment, the printer 5 is configured to register the type and the size of the sheet 7 set via the web browser 3 by the control section. Here, “configured to register” in “configured to register the type and the size of the sheet 7 set via the web browser 3” means that type and size of the sheet 7 is fixed in a changeable manner to a frequently used type and size from among the various types of the sheet 7, so that printing can be performed without performing setting processing each time. Selection via Operation Panel of Sheet Type that was Set

In response to the selection of the type and the size of the sheet 7 via the web browser 3, the user placed the sheet 7 in the sheet placed section 11. When the sensor 25 detects that the sheet 7 was placed in the sheet placed section 11, the control section shifts to the type setting mode in which the type of sheet 7 that was set, is set via the operation panel 9. Then, the user sets the type of the sheet 7 that was placed in the sheet placed section 11 to the type and the size of the sheet 7 selected via the web browser 3, and selects one of three types of “document”, “photo”, and “envelope” by the selection button 22.

As an example, it will be assumed that “document” shown in FIG. 3, that is, the sheet type is plain sheet and the sheet size is A4, was selected and set via the web browser 3. The user uses the selection button 22 on the operation panel 9 to select “document” from among three types of “document”, “photo”, and “envelope”. Accordingly, the control section of the printer 5 recognizes the type of the sheet 7 that was placed in the sheet placed section 11 and executes printing.

### Description of Effects of Embodiment

(1) According to the present embodiment, the operation panel 9 is configured to select and set the type of the sheet 7, which was placed in the printer 5, from among predetermined types, here, the three types of “document”, “photo”, and “envelope”. As a result, it is possible to reduce the risk of printing on another type of sheet by mistake with respect to the type and the size of the sheet 7 set via the web browser 3.

(2) According to the present embodiment, the printer 5 shifts to the type setting mode, with the sensor 25 detecting that the sheet 7 was placed in the sheet placed section 11 as a trigger. Thus, the user can use the operation panel 9 to set the type of sheet 7 that was set.

(3) According to the present embodiment, the operation panel 9 has three display sections 19, 21, and 23 corresponding to n types sheet, here, the three types of “document”, “photo”, and “envelope”. Thus, when any one of the three types of the sheet of “document”, “photo”, and “envelope” is selected by the operation panel 9 in a state of the type setting mode, the corresponding one of the three display sections 19, 21, and 23 is turned on, and the type of the selected sheet 7 can be confirmed. As a result, it can be easily confirmed that the correct sheet has been placed in the sheet placed section 11, and therefore, it is possible to reduce the possibility of printing on another type of the sheet by mistake.

(4) Further, according to the present embodiment, the predetermined types are the three types of “document”, “photo”, and “envelope”. Since these are often used as a classification display of the type of sheet 7, they are easy for the user to use.

(5) According to the present embodiment, the fact that the printer 5 has shifted to the type setting mode can be confirmed by the fact that all of the three display sections 19, 21, and 23 are turned on. Therefore, the user can easily recognize that the type of the sheet 7 is in a state in which the type of the sheet 7 can be selected and set from among predetermined types. Thus, it is possible to start the process of setting the type of the sheet 7.

(6) Further, according to the present embodiment, the type and the size of the sheet set via the web browser 3 can be registered. Thus, it is not necessary to perform a process of setting each time the type and the size that are frequently used by the user among various types of the sheet.

### Other Embodiments

The printing system 1 according to the present disclosure basically has the configuration of the embodiment described above, but it is needless to say that a partial change, omission, or the like of the configuration can be made without departing from the scope of the present disclosure.

In the above described embodiment, a case has been described in which the operation panel 9 selects any one of three types of “document”, “photo”, and “envelope” as the predetermined type, but the predetermined type is not limited to these three types. Further, although these icons are shown in the form of the document icon 13, the photograph icon 15, and the envelope icon 17, they are not limited to these forms, and may be configured using a liquid crystal panel, a two line LCD display, or a seven segment display.

In addition, selection of the type and the size of the sheet via the web browser is not limited to selection by software (WebConfig) via the web browser of the personal computer or a smartphone. For example, the setting may be performed via the web browser from a smart device such as a smartphone or a tablet terminal. It is also possible to communicate with the printer 5 by a protocol other than HTTP.

What is claimed is:

1. A printing system configured to perform various settings of a printer via a web browser wherein
the printer is configured for selection and setting of a type and a size of a sheet via the web browser and
an operation panel of the printer is configured to enable selection and setting, from among predetermined types, a type of the sheet that was placed in the printer.

2. The printing system according to claim 1, wherein
the printer includes a sensor configured to detect that the sheet was placed in a sheet placed section and
when the sensor detects that the sheet was placed in the sheet placed section, the printer shifts to a type setting mode for setting, via the operation panel, the type of the sheet that was placed in the sheet placed section.

3. The printing system according to claim 2, wherein
the predetermined types include n types of a first type, a second type, to an n-th type, wherein n is a positive integer,
the operation panel has n display sections corresponding to the n types, and
the type setting mode enables selection of any one type of sheet from the n types of sheets.

4. The printing system according to claim 3, wherein
the predetermined types are document, photograph, and envelope.

5. The printing system according to claim 3, wherein
the operation panel enables confirmation that the mode has been shifted to the type setting mode by turning on all of the n display sections.

6. The printing system according to claim 1, wherein
the printer is configured to register the type and the size of the sheet set via the web browser.
